(19) United States
(12) Patent Application Publication
(10) Pub. No.: US 2009/0155013 A1
(43) Pub. Date: Jun. 18, 2009

(54) Fastener Engaged In Gaps Between Thin Sheets

(76) Inventor: Robert Liang, Taoyuan (TW)

Correspondence Address: LIN & ASSOCIATES INTELLECTUAL PROPERTY, INC., P.O. BOX 2339, SARATOGA, CA, 95070-0339, US

(21) Appl. No.: 11/958,386

(22) Filed: Dec. 18, 2007

(51) Int. Cl. F16B 13/04

(52) U.S. Cl. 411/26

(57) ABSTRACT

A fastener engaged in gaps between thin sheets for connecting for example a fan to a heatsink is disclosed herein, which includes a plurality of side plates defining a space between two adjacent side plates, and a connection board connecting the side plates at one side thereof. The connection board has a protrusion extending toward the space between the side plates. The side plates are engaged into the gaps between the thin sheets, such as fins of the heatsink, and the protrusions are engaged into other gaps for securing the fastener to the thin sheets, in such a way that the fan can be stably screwed to the connection board of the fasteners and further mounted to the heatsink.

### BACKGROUND OF THE INVENTION

1. Field of the Invention

The present invention relates to a fastener engaged in gaps between thin sheets for connecting for example a fan to a heatsink, which is helpful to easily and securely install the fan to the heatsink.

2. The Prior Arts

A heat dissipating module is widely used to remove the heat generated from a heat source such as a computer, so as to prevent damaging the electronic components of the computer. To remove a large amount of heat, the heat dissipating module comprises a heatsink having a plurality of fins, and a plurality of heat conduction pipes connected with the plurality of fins. An end of the heat conduction pipes is connected to a heat conduction plate that is adhered to the heat source by using a heat conduction glue coated between the heat conduction plate and the heat source. Furthermore, the heatsink can be equipped with a fan thereon. Therefore, the heat generated from the heat source can be transferred to the fins through the conduction pipes and then be dissipated out by the fan on the heatsink.

The plurality of fins on the heatsink are thin metal plates formed by pressing technique. The combination of the fins and the heat conduction pipes is an excellent design of heat dissipation. However, when it is required to install the fan on the heatsink to enhance the heat dissipation, the fins are too thin (about 0.3-0.5 mm) so that the fan can not be stably and securely fastened to the heatsink. Therefore, the fan will be easily disengaged from the heatsink due to vibration of the fan during operation.

### SUMMARY OF THE INVENTION

An objective of the present invention is to provide a fastener engaged in gaps between thin sheets for connecting for example a fan to a heatsink, which provides a strengthen piece for securely installing the fan on the heatsink, and therefore the fan can not be easily disengaged from the heatsink due to vibration of the fan during operation.

According to the present invention, a fastener engaged in gaps between thin sheets for connecting for example a fan to a heatsink is provided, which includes a plurality of side plates defining a space between two adjacent side plates, and a connection board connecting the side plates at one side thereof. The connection board has a protrusion extending toward the space between the side plates. The side plates are engaged into gaps between the thin sheets, such as fins of the heatsink, and the protrusions are engaged into other gaps for securing the fastener to the thin sheets, in such a way that the fan can be stably screwed to the connection board of the fasteners and further mounted to the heatsink.

The side plate of the fastener in accordance with the present invention preferably is a rectangular plate, which is easily fabricated.

According to the present invention, a length of the side plate connected to the connection board is smaller than one half length of the side plate, for saving the manufacturing cost.

According to the present invention, a thickness of the protrusion is slightly smaller than a width of the gap between two thin sheets, for being stably engaged into the gap.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a fastener in accordance with the present invention;

FIG. 2 is another perspective view of the fastener in accordance with the present invention;

FIG. 3 is an exploded view showing that the fastener in accordance with the present invention is mounted to fins;

FIG. 4 is a perspective view showing that the fastener in accordance with the present invention is mounted to fins for connecting a fan to a heatsink; and

FIG. 5 is a cross-sectional view showing that the fastener in accordance with the present invention is engaged into gaps between the fins.

### DETAILED DESCRIPTION OF THE PREFERRED EMBODIMENT

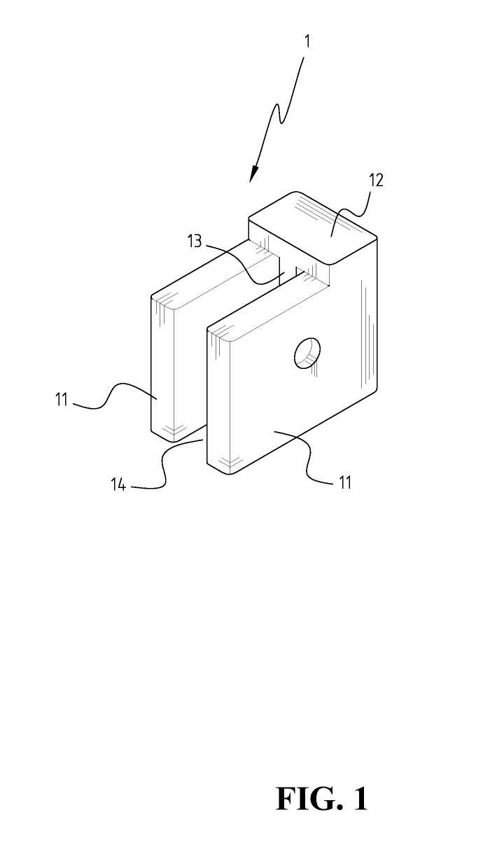

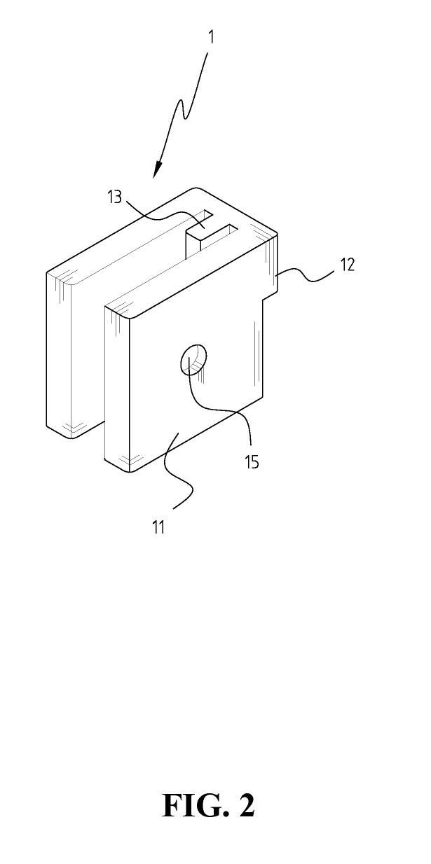

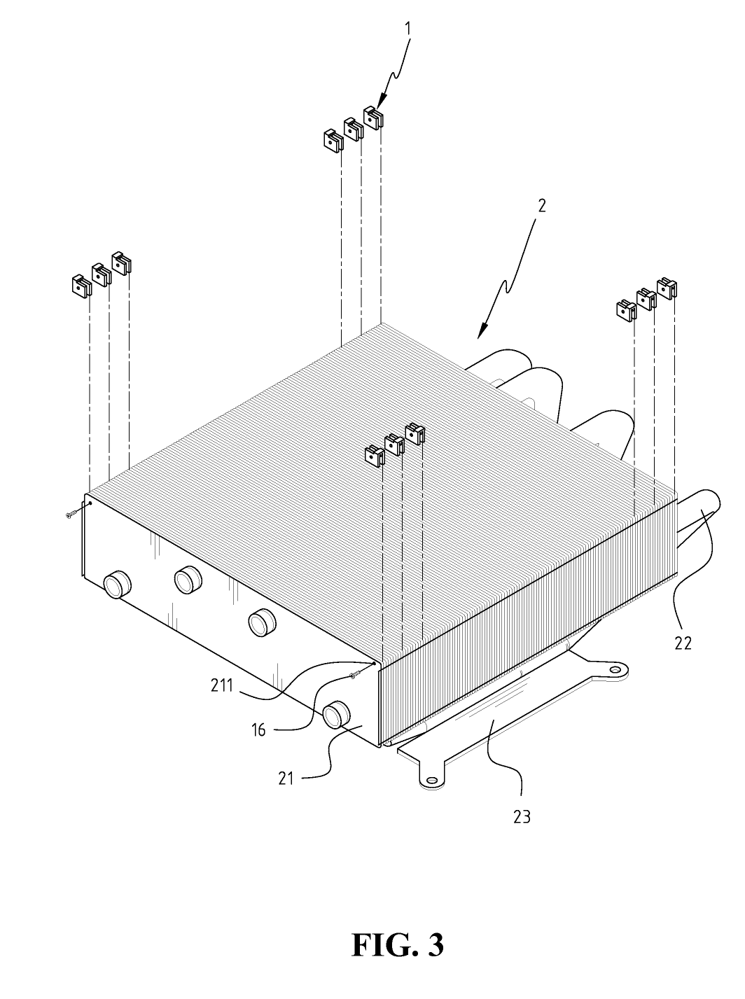

With reference to the drawings and in particular to FIG. 1 and FIG. 2, a fastener 1 engaged in gaps between thin sheets for connecting for example a fan to a heatsink in accordance with the present invention comprises two parallel side plates 11 defining a space 14 there between, a connection board 12 connecting the two side plates 11 at one side thereof. The side plate 11 is preferably a rectangular plate, and has at least one through hole 15 therein. A length of the side plate 11 connected to the connection board 12 is preferably smaller than one half length of the side plate 11, so as to decrease the manufacturing cost of the fastener 1. The connection board 12 has an area sufficient for a screw locked thereinto. The connection board 12 has a protrusion 13 extending toward the space 14 between the two side plates 11. A thickness of the protrusion 13 is slightly smaller than a width of a gap between fins 21 (see FIG. 3).

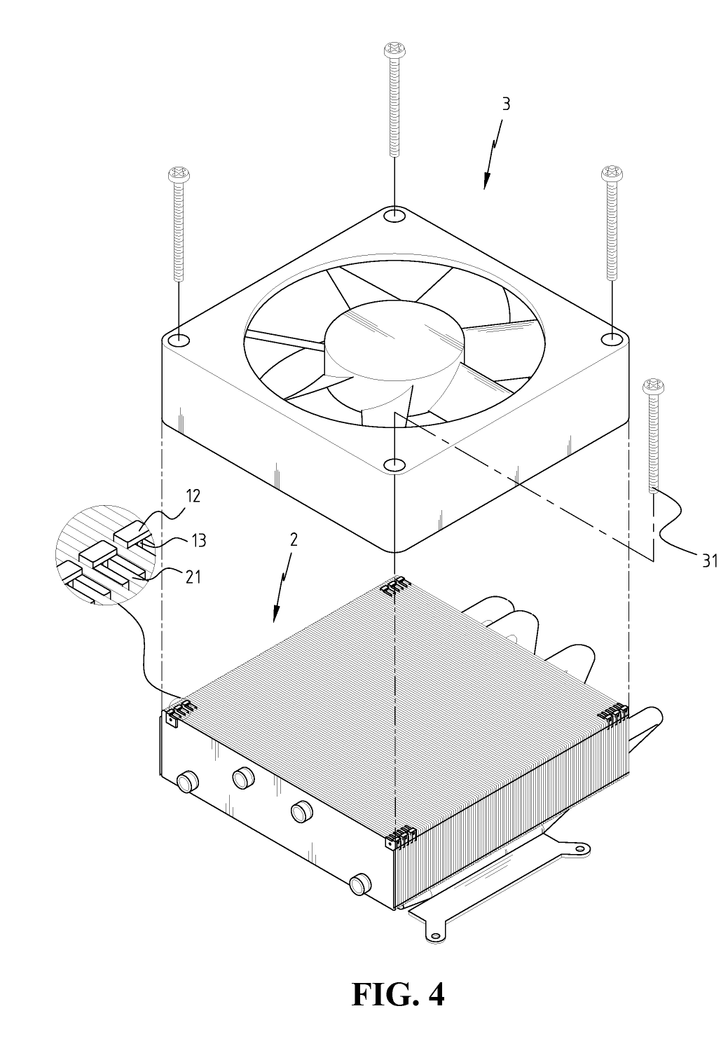

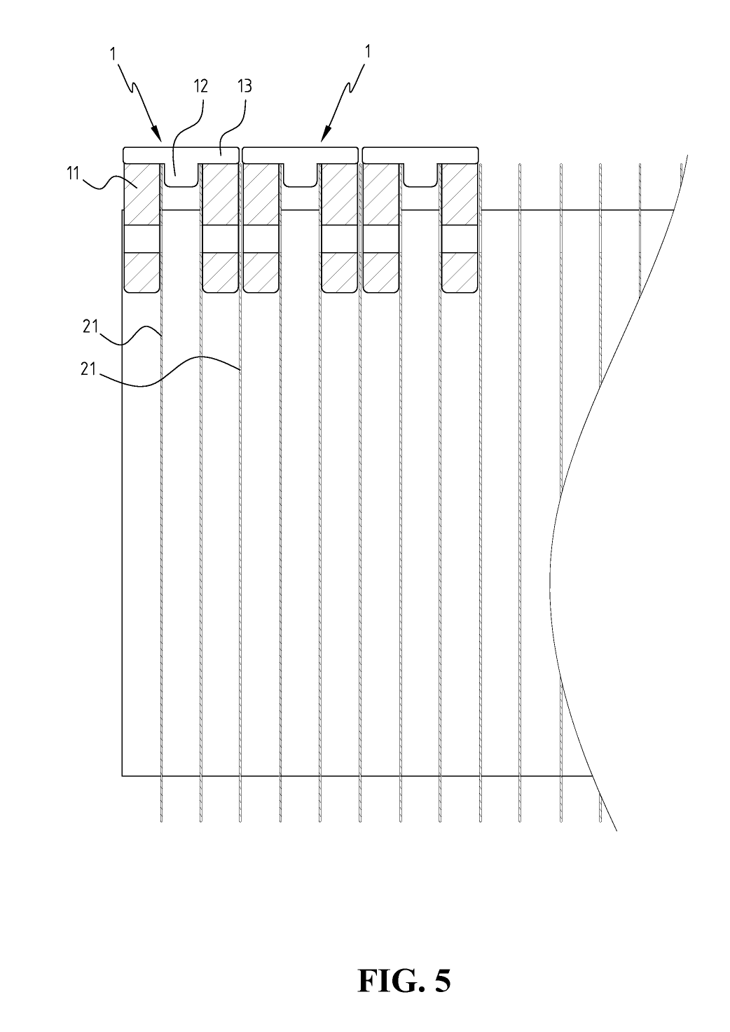

FIG. 3 and FIG. 4 show that the fastener 1 in accordance with the present invention is assembled to the heatsink 2. In assembling the fastener 1 to the heatsink 2, the two side plates 11 are engaged into gaps between fins 21 of the heatsink 2, and the protrusion 13 is also engaged into another gap between the fins 21 for securing the fastener 1 to the fins 21. At this time, the connection board 12 is rested on end surfaces of the fins 21 (see FIG. 5), and the through holes 15 defined on the side plates 11 are corresponded to screw holes 211 on the fins 21. A screw 16 inserts through the through hole 15 and the screw holes 211 to further fix the fastener 1 in the fins 21. As shown in FIG. 4, a fan 3 is mounted onto the heatsink 2 by inserting screws into a screw hole (not shown) defined in the connection board 13 of the fastener 1.

The heatsink 2 is generally used to dissipate heat generated from a chipset of a computer. The heatsink 2 includes a plurality of fins 21 made by a material, such as a metal, with excellent heat conductivity, and a plurality of the heat conduction pipes 22 connected with the plurality of the fins 21. The heat conduction pipes 22 are made by copper. An end of the heat conduction pipe 22 is connected to a heat conduction plate 23 that is adhered to the heat source, such as a CPU, by using a heat conduction glue (not shown) coated between the heat conduction plate and the heat source. The heat generated from the heat source can be transferred to the fins 21 through the heat conduction pipes 22 and then be dissipated out by the fan 3 mounted on the heatsink 2.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A fastener engaged in gaps between thin sheets for easily connecting an object thereto, the fastener comprising:
a plurality of side plates defining a space between two adjacent side plates; and
a connection board connecting the side plates at one side thereof, the connection board having a protrusion extending toward the space between the side plates.

2. The fastener as claimed in claim 1, wherein the side plate is a rectangular plate.

3. The fastener as claimed in claim 1, wherein a thickness of the protrusion is slightly smaller than a width of a gap between two thin sheets.
